(19) United States
(12) Patent Application Publication
(10) Pub. No.: US 2019/0114386 A1
(43) Pub. Date: Apr. 18, 2019

(54) RECORDING MEDIUM FOR RECORDING FASTENING MEMBER CONTINUITY DETERMINATION PROGRAM, FASTENING MEMBER CONTINUITY DETERMINATION METHOD, AND INFORMATION PROCESSING APPARATUS

(71) Applicant: FUJITSU LIMITED, Kawasaki-shi (JP)

(72) Inventors: Yoshiaki Hiratsuka, Ota (JP); Koji DEMIZU, Atsugi (JP)

(73) Assignee: FUJITSU LIMITED, Kawasaki-shi (JP)

(21) Appl. No.: 16/143,693

(22) Filed: Sep. 27, 2018

(30) Foreign Application Priority Data
Oct. 16, 2017 (JP) 2017-200586

(51) Int. Cl. G06F 17/50; G01B 7/14

(52) U.S. Cl. CPC G06F 17/5086; G06F 17/5009; G01B 7/14

(57) ABSTRACT

A recording medium recording a program that causes a computer to execute a process includes acquiring data including information indicating a shape and a position of a fastening member having a cylindrical fastening portion and information indicating a shape and a position of a fastened member having a hole in which an inner wall is disposed to be isolated from an outer periphery of the fastening portion, generating distance information of a distance between the outer periphery of the fastening portion and the inner wall, determining whether the fastening member and the fastened member are fitted based on the distance information, determining, when the fastening member and the fastened member are fitted, whether materials of the fastening member and the fastened member are conductive, and outputting, when the materials are conductive, continuity information indicating that the fastening member and the fastened member are in a continuity state.

### CROSS-REFERENCE TO RELATED APPLICATION

This application is based upon and claims the benefit of priority of the prior Japanese Patent Application No. 2017-200586, filed on Oct. 16, 2017, the entire contents of which are incorporated herein by reference.

### FIELD

The embodiments discussed herein are related to a recording medium for recording a fastening member continuity determination program, a fastening member continuity determination method, and an information processing apparatus.

### BACKGROUND

In the design of mechanical parts such as electronic devices, a process of determining an assembly state of a member including a process of determining whether a fastening member such as a screw and a member to be fastened such as a substrate are fitted is performed on a three-dimensional model using a computer aided design (CAD).

Related techniques are disclosed in, for example, Japanese Laid-Open Patent Publication Nos. 2009-123060, 2011-238008, and 2008-065708.

### SUMMARY

A non-transitory computer-readable recording medium recording a fastening member continuity determination program that causes a computer to execute a process, the process includes: acquiring design data including information indicating a shape and a position of a fastening member having a cylindrical fastening portion and information indicating a shape and a position of a fastened member having a hole in which an inner wall is disposed to be isolated from an outer periphery of the fastening portion; generating distance information related to a distance between the outer periphery of the fastening portion and the inner wall of the hole; determining whether the fastening member and the fastened member are fitted to each other based on the distance information; determining, when determining that the fastening member and the fastened member are fitted to each other, whether materials of both the fastening member and the fastened member are conductive; and outputting, when determining that the materials of both the fastening member and the fastened member are conductive, continuity information indicating that the fastening member and the fastened member are in a continuity state.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1A illustrates an example of a plan view of an electronic device;

FIG. 1B illustrates an example of a cross-sectional view taken along the line A-A′ illustrated in FIG. 1A;

FIG. 2A illustrates an example of a circuit of an information processing apparatus that executes an installation position determination process;

FIG. 2B illustrates an example of a functional block of a processing unit;

FIG. 3 illustrates an example of a classification table illustrated in FIG. 2A;

FIG. 4 illustrates an example of a fastening member continuity determination process performed by the information processing apparatus illustrated in FIG. 2A;

FIG. 5A illustrates an example of the fastening member continuity determination process performed by the information processing apparatus illustrated in FIG. 4A;

FIG. 5B illustrates an example of process S103 illustrated in FIG. 5A;

FIG. 6A illustrates an example of a circuit of an information processing apparatus that executes an installation position determination process;

FIG. 6B illustrates an example of a functional block of a processing unit illustrated in FIG. 6A;

FIG. 7 illustrates an example of the fastening member continuity determination process;

FIG. 8A illustrates an example of the fastening member continuity determination process performed by the information processing apparatus;

FIG. 8B illustrates an example of process S303 illustrated in FIG. 8A;

FIG. 9A illustrates an example of a circuit block of an information processing apparatus that executes an installation position determination process;

FIG. 9B illustrates an example of a functional block of a processing unit illustrated in FIG. 9A;

FIG. 10 illustrates an example of the fastening member continuity determination process performed by the information processing apparatus illustrated in FIG. 9A;

FIG. 11A illustrates an example of the fastening member continuity determination process performed by the information processing apparatus illustrated in FIG. 10;

FIG. 11B illustrates an example of process S503 illustrated in FIG. 11A;

FIG. 12A illustrates an example of a circuit block of an information processing apparatus that executes an installation position determination process;

FIG. 12B illustrates an example of a functional block of a processing unit illustrated in FIG. 12A;

FIG. 13 illustrates an example of the fastening member continuity determination process performed by the information processing apparatus illustrated in FIG. 12A;

FIG. 14A illustrates an example of the fastening member continuity determination process performed by the information processing apparatus illustrated in FIG. 12A, and

FIG. 14B illustrates an example of process S703 illustrated in FIG. 14A.

### DESCRIPTION OF EMBODIMENTS

A process of determining whether a screw and a member to be fastened with the screw are fitted to each other is executed, for example, based on the shape of a screw head. For example, a process of determining whether a male screw and a member having a female screw to be fitted to the male screw are fitted to each other is executed based on whether an outer circumferential portion of the male screw and an inner circumferential portion of the female screw are overlapped with each other.

For example, a countermeasure against the electromagnetic noise radiated from an electronic device also called electromagnetic interference (EMI) is required. Since the electromagnetic noise radiated from the electronic device is generated according to an operation of a clock of an electric circuit mounted on, for example, a printed circuit board, the electromagnetic noise increases as an operating frequency of a signal clock increases. The electromagnetic noise radiated from the electronic device is reduced by setting an arrangement interval of the fastening components such as the screw which connect the components mounted on the electronic device to each other to be, for example, ¼ or less of the wavelength corresponding to the operating frequency of the clock. For example, in the electronic device where as many as approximately 500 fastening members are arranged, the arrangement interval of the fastening members may be verified by using a check function mounted on the CAD.

For example, the screws used as the fastening members have threads. Therefore, when the fastening member having the thread is faithfully intended to be reproduced in CAD data, a data amount of the CAD data may increase. In order to prevent the data amount of the CAD data from being increased, the fastening member having the thread may be defined in the CAD data as a cylindrical shape having no thread.

For example, in the CAD data, when a fastening member and a member to be fastened (a fastened member) by the fastening member are arranged to be in contact with each other, a problem such as an occurrence of an unnecessary error due to the interference between the fastening member and the fastened member may occur in the CAD. In the CAD data, the cylindrical fastening member may be disposed not to contact an inner wall of a hole for fitting the fastening member formed in the fastened member in order to prevent the problem from being occurred in the CAD by the interference of the fastening member and the fastened member.

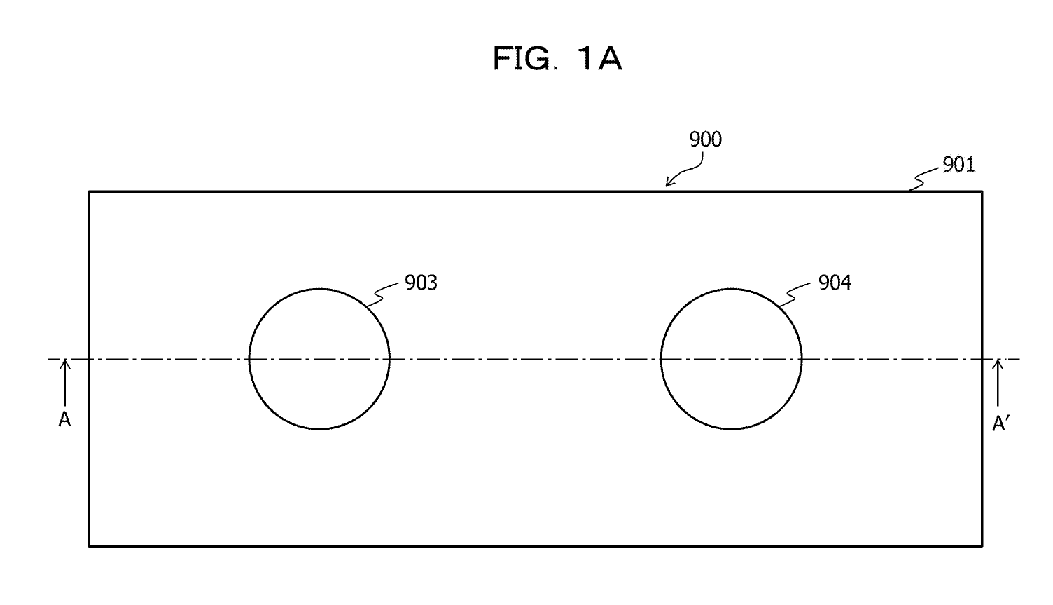

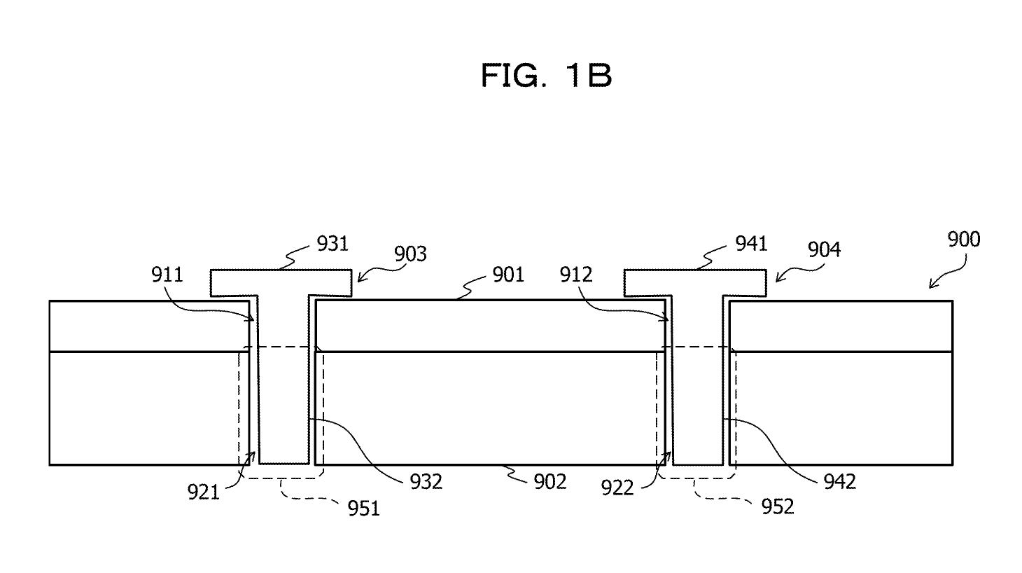

FIG. 1A illustrates an example of a plan view of an electronic device. FIG. 1B illustrates an example of a cross-sectional view taken along the line A-A′ illustrated in FIG. 1A.

An electronic device 900 includes a first member 901, a second member 902, a first fastening member 903, and a second fastening member 904. A first hole 901 and a second hole 912 are formed in the first member 901, and a first hole 921 and a second hole 922 are formed in the second member 902. The first fastening member 903 has a screw head 931 and a fastening portion 932 in which threads are formed. The second fastening member 904 has a screw head 941 and a fastening portion 942 in which the threads are formed. The second member 902 is a fastened member fastened in the fastening portion 932 of the first fastening member 903 and at the same time to be fastened in the fastening portion 942 of the second fastening member 904. The first member is sandwiched by the second member 902 fastened to the first fastening member 903 and the second fastening member 904, and the screw head 931 of the first fastening member 903 and the screw head 941 of the second fastening member 904.

The second member 902 is fastened to the first fastening member 903 and the second fastening member 904, but in the CAD data, as indicated by the broken lines 951 and 952, the first hole 921 and the second hole 922 of the second member 902 are disposed to be isolated from the first fastening member 903 and the second fastening member 904. For example, in the CAD data, the inner wall of the first hole 921 of the second member 902 is disposed to be isolated from an outer periphery of the fastening portion 932 of the first fastening member 903, and the inner wall of the second hole 922 of the second member 902 is disposed to be isolated from the outer periphery of the fastening portion 942 of the second fastening member 904. Since the second member 902, and the first fastening member 903 and the second fastening member are disposed to be isolated from each other in the CAD data, the fact whether the second member 902, and the first fastening member 903 and the second fastening member are in a continuity state is not easily determined based on the CAD data.

For example, when the fastening member and the fastened are disposed to be isolated from each other in the CAD data, a technique may be provided which is capable of determining whether the fastening member and the member to be fastened are in the continuity state.

(Outline of Information Processing Apparatus)

The information processing apparatus determines that the fastening member and the fastened member are fitted to each other based on distance information related to a distance between the outer periphery of the cylindrical fastening portion and the inner wall of the hole of the fastened member surrounding the fastening portion. When determining that the fastening member and the fastened member are fitted to each other, the information processing apparatus determines whether materials of both the fastening member and the fastened member are conductive. In addition, when determining that the materials of both the fastening member and the fastened member are conductive, the information processing apparatus outputs continuity information indicating that the fastening member and the fastened member are in a continuity state. By executing such a process, the information processing apparatus may determine whether the fastening member and the fastened member are in the continuity state even when the fastening portion of the fastening member and the hole of the fastened member are disposed to be isolated from each other in the CAD data.

(Configuration and Function of Information Processing Apparatus Executing Installation Position Determination Process According to First Embodiment)

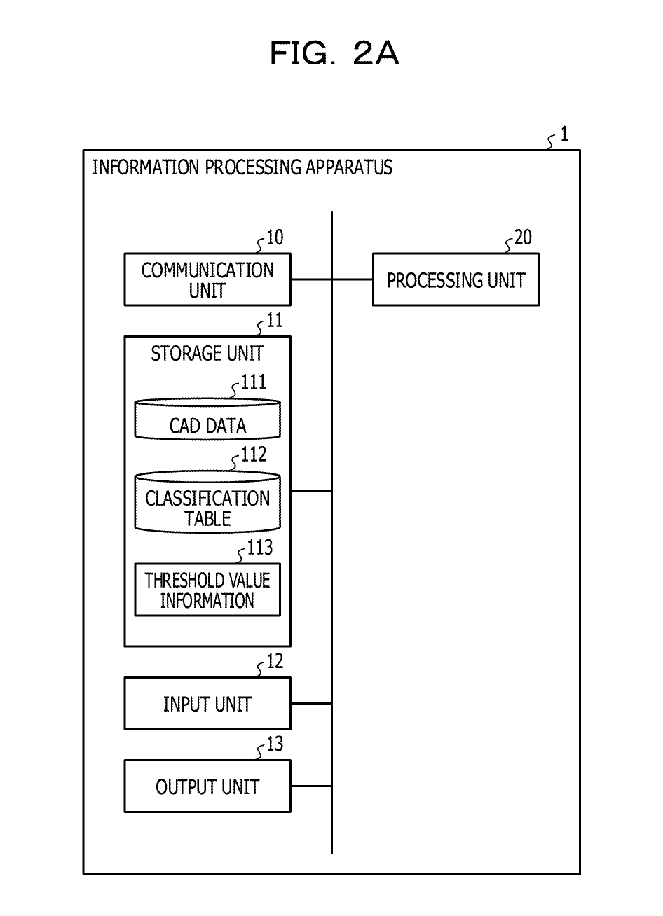

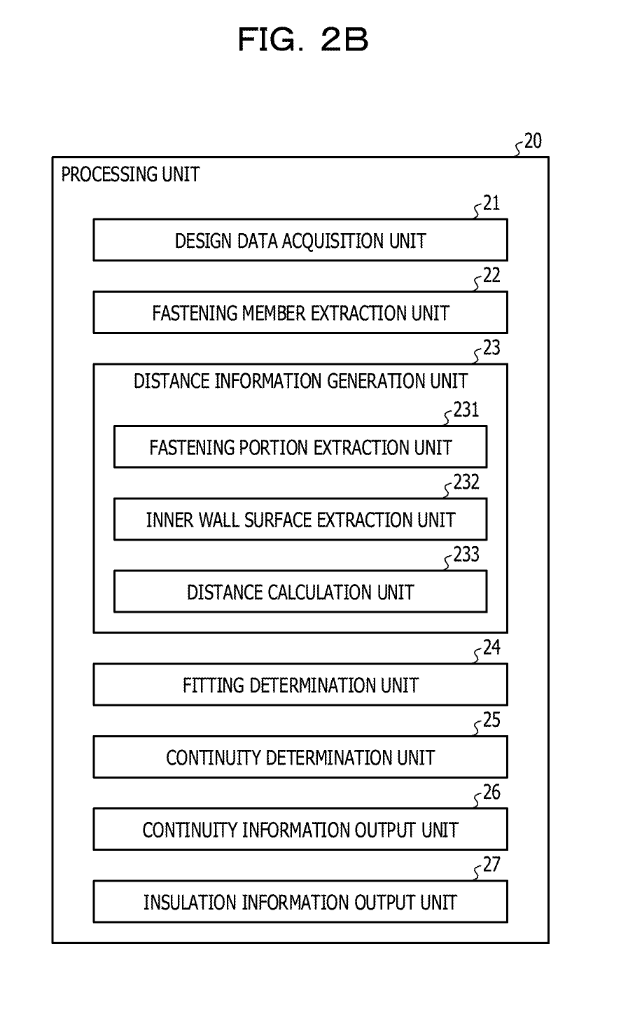

FIG. 2A is a circuit block diagram of an information processing apparatus that executes an installation position determination process and FIG. 2B is a functional block diagram of a processing unit illustrated in FIG. 2A.

The information processing apparatus 1 includes a communication unit 10, a storage unit 11, an input unit 12, an output unit 13, and a processing unit 20.

The communication unit 10 communicates with a server (not illustrated) or the like via the Internet according to the Hypertext Transfer Protocol (HTTP). In addition, the communication unit 10 supplies data received from, for example, the server to the processing unit 20. In addition, the communication unit 10 transmits the data supplied from the processing unit 20 to, for example, the server.

The storage unit 11 includes, for example, at least one of a magnetic tape device, a magnetic disk device, and an optical disk device. The storage unit 11 stores an operating system program, a driver program, an application program, data, and the like used for processing in the processing unit 20. For example, the storage unit 11 stores, as the application program, a fastening member continuity determination program for executing the fastening member continuity determination process of determining whether the fastening member and the fastened member are in a continuity state to each other. The fastening member continuity determination program may be installed in the storage unit 11 from a computer-readable portable recording medium such as a CD-ROM or DVD-ROM using, for example, a known setup program.

Further, the storage unit 11 stores various data used in the fastening member continuity determination process. Moreover, the storage unit 11 may temporarily store temporary data relating to a predetermined process. The storage unit 11 stores CAD data 111, a classification table 112, and threshold value information 113 including a threshold value used in the fastening member continuity determination process. The CAD data 111 indicates design data designed by a designer and includes information indicating the shape and a position of a member of an electronic device including the fastening member and the fastened member to be fitted to the fastening member. For example, the CAD data 111 includes information indicating the shape and the position of the fastening member having the cylindrical fastening portion and information indicating the shape and the position of the fastened member having the hole in which the outer periphery of the fastening portion of the fastening member is disposed to be isolated from the inner wall.

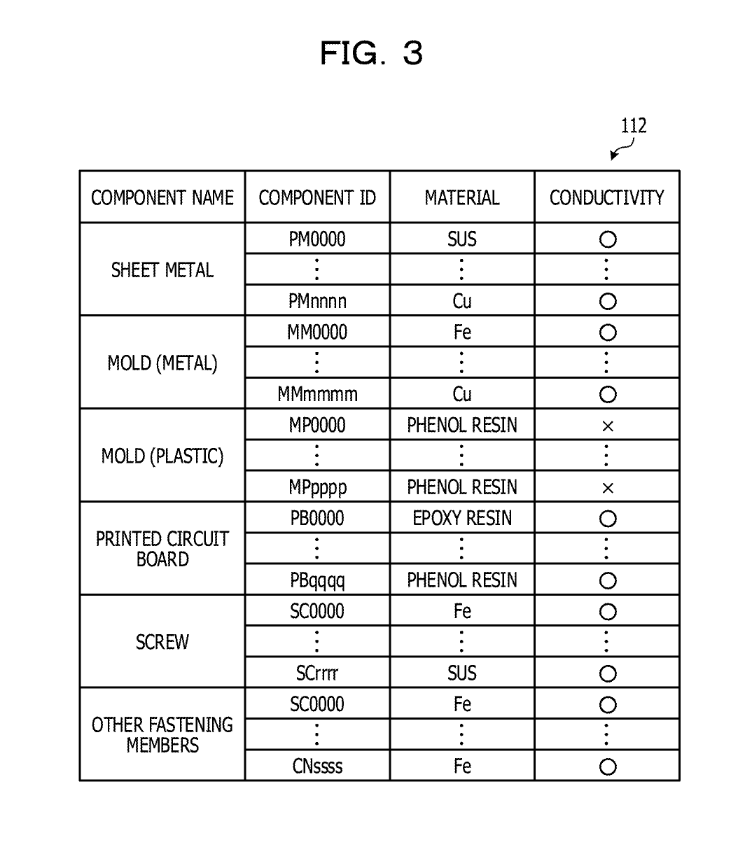

FIG. 3 illustrates an example of a classification table 112.

The classification table 112 stores a component name, a component ID, a material, and whether the component is conductive in association with each of the components mounted on the electronic device. The component name indicates the name of each component to be mounted on the electronic device and may include, for example, a sheet metal, a mold (metal) representing a metallic mold, a mold (plastic) representing a mold made of a synthetic resin, a printed circuit board, the screw, and other fastening member items representing the fastening member other than the screw. The part ID indicates an identifier corresponding to an identifier of each component included in the CAD data 111. The material indicates the material of each of the components mounted on the electronic device and may include, for example, SUS representing stainless steel, Fe representing steel, Cu representing copper, and a synthetic resin such as an epoxy resin and a phenol resin. The fact whether the component is conductive is represented by an expression including “o” indicating a conductivity and “x” indicating an insulation.

The threshold value information 113 may include a single threshold value or a plurality of threshold values. The threshold value is, for example, a difference between a diameter of a valley of the thread of the fastening member and a desired diameter of the hole formed in the fastened member. The threshold value information 113 may include a plurality of threshold values corresponding to respective types of fastening members such as a screw defined by a predetermined standard such as, for example, the JIS standard.

The input unit 12 may be any device as long as data may be input, such as, for example, a touch panel or a key button. An operator may input, for example, letters, numbers, and symbols using the input unit 12. When the input unit 12 is operated by the operator, the input unit 12 generates a signal corresponding to the operation. In addition, the generated signal is supplied to the processing unit 20 by an instruction of the operator.

The output unit 13 may be any device as long as the output unit 13 may display an image or a frame and be, for example, a liquid crystal display or an organic electro-luminescence (EL) display. The output unit 13 displays the image depending on image data supplied from the processing unit 20 or the frame depending on moving picture data.

The processing unit 20 includes one or a plurality of processors or peripheral circuits thereof. The processing unit 20 collectively controls an overall operation of the information processing apparatus 1 and is, for example, a CPU. The processing unit 20 executes the process based on the program stored in the storage unit 11 (driver program, operating system program, application program, etc.). Further, the processing unit 20 may execute a plurality of programs (e.g., application programs) in parallel.

The processing unit 20 includes a design data acquisition unit 21, a fastening member extraction unit 22, a distance information generation unit 23, a fitting determination unit 24, a continuity determination unit 25, a continuity information output unit 26, and an insulation information output unit 27. The distance information generation unit 23 includes a fastening unit extraction unit 231, an inner wall surface extraction unit 232, and a distance calculation unit 233. Each of the units is a functional module implemented by a program executed by a processor included in the processing unit 20. Alternatively, each of the units may be mounted on the information processing apparatus 1 as firmware.

(Fastening Member Continuity Determination Process by Information Processing Apparatus According to First Embodiment)

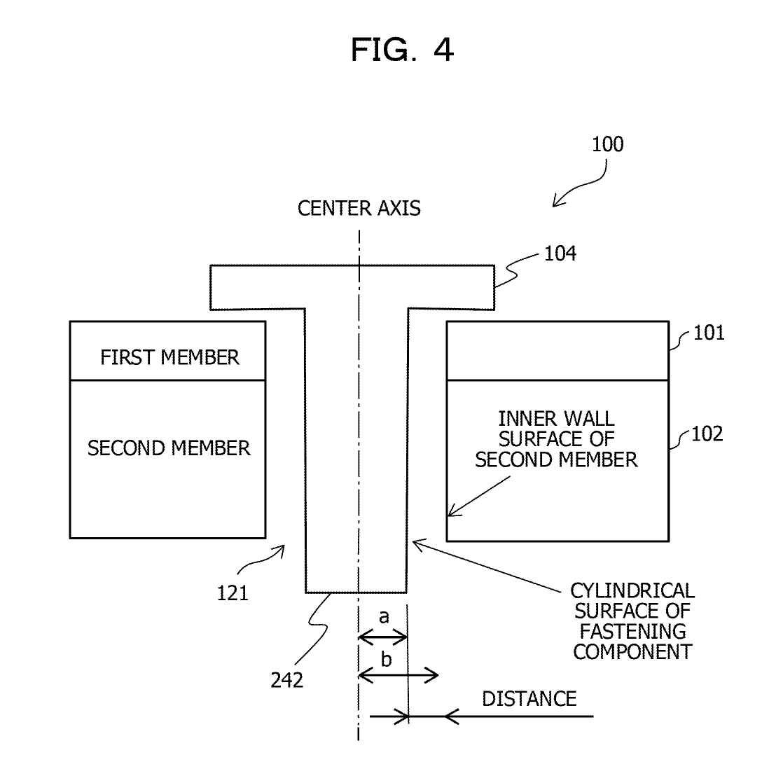

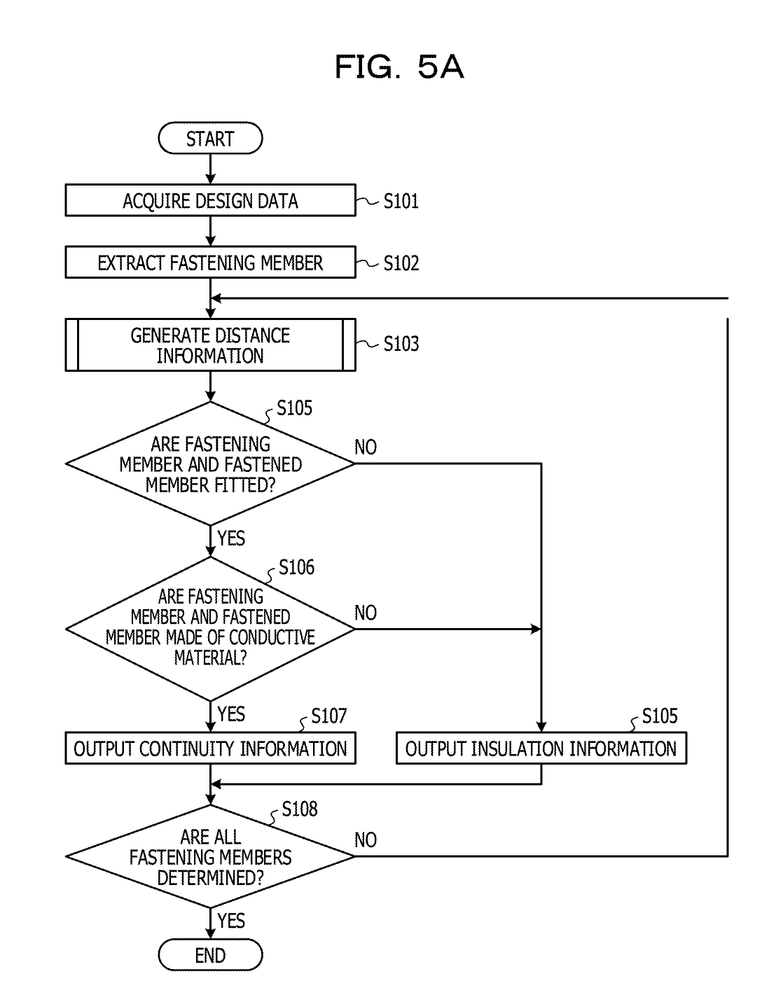

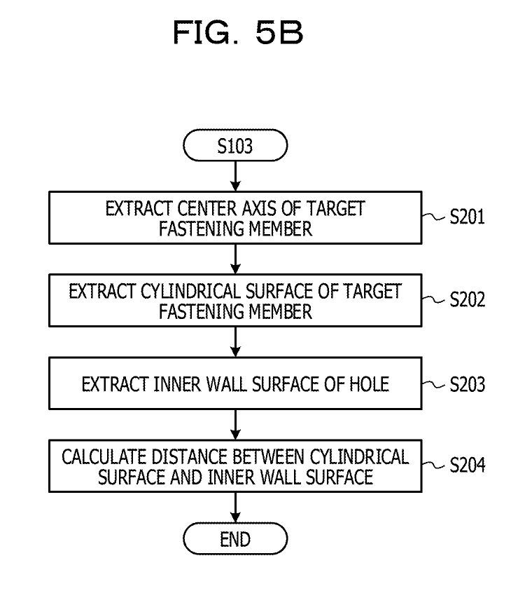

FIG. 4 is a diagram illustrating a fastening member continuity determination process performed by the information processing apparatus 1, FIG. 5A is a flowchart of the fastening member continuity determination process by the information processing apparatus 1, and FIG. 5B is a flowchart illustrating a more detailed process of process S206 illustrated in FIG. 5A. The fastening member continuity determination process illustrated in FIG. 5A is executed mainly by the processing unit 20 in cooperation with each element of the information processing apparatus 1 based on the program stored in advance in the storage unit 11.

The fastening member continuity determination process performed by the information processing apparatus 1 will be described by taking the electronic device 100 having the first member 101, the second member 102, and the fastening member 104 illustrated in FIG. 4, as an example. When the distance between a cylindrical surface of the fastening portion of the fastening member 104 and an inner wall surface of a hole 121 formed in the second member 102 is equal to or less than a predetermined threshold value, the information processing apparatus 1 determines that the second member 102 and the fastening member 104 are fitted to each other. As an example, the information processing apparatus 1 calculates a difference between a diameter a of the fastening portion 142 and a diameter b of the hole 121 as the distance between the cylindrical surface of the fastening portion of the fastening member 104 and the inner wall surface of the hole 121 formed in the second member 102. Moreover, when determining that the materials of both the second member 102 and the fastening member 104 are conductive materials, the information processing apparatus 1 outputs continuity information indicating that the second member 102 and the fastening member 104 are in a continuity state.

First, the design data acquisition unit 21 acquires the CAD data 111 (S101). Next, the fastening member extraction unit 22 extracts the fastening member from the information included in the CAD data 111 (S102). The fastening member extraction unit 22 extracts the component IDs associated with the screws and other fastening members by referring to the classification table 112 to extract the fastening member from the information included in the CAD data 111 regarding the component corresponding to the component ID extracted from the classification table 112.

The distance information generation unit 23 generates the distance information related to the distance between the outer periphery of the fastening portion of a target fastening member which is any one of the fastening member extracted by process S102 and the inner wall of the hole of a target fastened member surrounding the periphery of the fastening portion of the target fastening member (S103).

The fastening portion extraction unit 231 extracts a center axis of the target fastening member (S201). For example, the fastening portion extraction unit 231 extracts a center point of the screw head of the screw to extract a straight line extending from the center point extracted in a direction orthogonal to a plane forming the screw head as the center axis of the screw.

Next, the fastening portion extraction unit 231 extracts the cylindrical surface of the target fastening member (S202). For example, the fastening portion extraction unit 231 extracts the center axis of the screw extracted by process S103 and the cylindrical surface of the screw from a cylindrical radius forming a fitting portion of the screw.

Next, the inner wall surface extraction unit 232 extracts the inner wall surface of the hole formed in the target fastened member facing the cylindrical surface extracted by process S202 (S203). For example, the inner wall surface extraction unit 232 may extract the component having the hole with the center axis which is the same as the center axis extracted by process S201 from the information included in the CAD data 111 to extract the inner wall surface of the hole formed in the target fastened member from the information indicating the hole of the extracted component.

Next, the distance calculation unit 233 calculates the distance between the cylindrical surface extracted by process S202 and the inner wall surface extracted by process S203 (S204). For example, the distance calculation unit 233 may calculate an average distance between the cylindrical surface and the inner wall surface as the distance between the cylindrical surface and the inner wall surface, and may calculate a maximum distance or a minimum distance between the cylindrical surface and the inner wall surface as the distance between the cylindrical surface and the inner wall surface.

Next, the fitting determination unit 24 determines whether the fastening member and the fastened member are fitted to each other (S104). Specifically, when the distance calculated in process S103 is equal to or smaller than the threshold value included in the threshold value information 113, the fitting determination unit 24 determines that the target fastening member and the target fastened member are fitted to each other (“YES” in S104). Meanwhile, when the distance calculated in process S103 is larger than the threshold value included in the threshold value information 113, the fitting determination unit 24 determines whether the target fastening member and the target fastened member are not fitted (“NO” in S104).

When it is determined by the fitting determination unit 24 that the target fastening member and the target fastened member are not fitted to each other (“NO” in S104), the insulation information output unit 27 outputs insulation information indicating that the target fastening member and the target fastened member are in an insulation state (S105).

When it is determined by the fitting determination unit 24 that the fastening member and the target fastened member are fitted to each other (“YES” in S104), the continuity determination unit 25 determines whether the materials of both the target fastening member and the target fastened member are conductive (S106). For example, the continuity determining unit 25 acquires materials associated with the target fastening member and the target fastened member, respectively, with reference to the classification table 112 to determine whether the materials of both the target fastening member and the target fastened member are conductive. Further, for example, the continuity determination unit 25 acquires whether the materials associated with the target fastening member and the target fastened member, respectively, are conductive with reference to the classification table 112 to determine whether the materials of both the target fastening member and the target fastened member are conductive. The continuity determination unit 25 may determine whether the materials of both the target fastening member and the target fastened member are conductive by extracting whether the materials are conductive to prevent the target fastened member from being mistakenly determined as a conductive member, for example, when the target fastened member is formed by a coated steel plate.

When it is determined by the continuity determination unit 25 that the materials of both the target fastening member and the target fastened member are conductive (“YES” in step S106), the continuity information output unit 26 outputs the continuity information indicating that the target fastening member and the target fastened member are in the continuity state (S107).

When it is determined by the continuity determination unit 25 that the materials of both the target fastening member and the target fastened member are not conductive (“NO” in step S106), the insulation information output unit 27 outputs the insulation information (S105).

Next, the distance information generation unit 23 determines whether processes S103 to S107 are executed with respect to all fastening members extracted by process S102 (S108). Processes S103 to S108 are repeated until it is determined by the distance information generation unit 23 that processes S103 to S107 are executed with respect to all of the fastening members extracted by process S102 (“YES” in S108). When it is determined by the distance information generation unit 23 that processes S103 to S107 are executed with respect to all of the fastening members extracted by process S102 (“YES” in S108), the process ends.

(Operation and Effect of Information Processing Apparatus According to First Embodiment)

The information processing apparatus according to the first embodiment determines that the fastening member and the fastened member are fitted to each other when the distance between the outer periphery of the fastening portion of the fastening member and the inner wall of the hole of the fastened member is equal to or smaller than a predetermined threshold value. When it is determined that the fastening member and the fastened member are fitted to each other, the information processing apparatus determines whether the materials of both the fastening member and the fastened member are conductive. In addition, when it is determined that the materials of both the fastening member and the fastened member are conductive, the information processing apparatus outputs continuity information indicating that the fastening member and the fastened member are in the continuity state. By executing such a process, the information processing apparatus may determine whether the fastening member and the fastened member are in the continuity state even when the fastening member and the fastened member are disposed to be isolated from each other in the CAD data.

(Configuration and Function of Information Processing Apparatus Executing Installation Position Determination Process According to Second Embodiment)

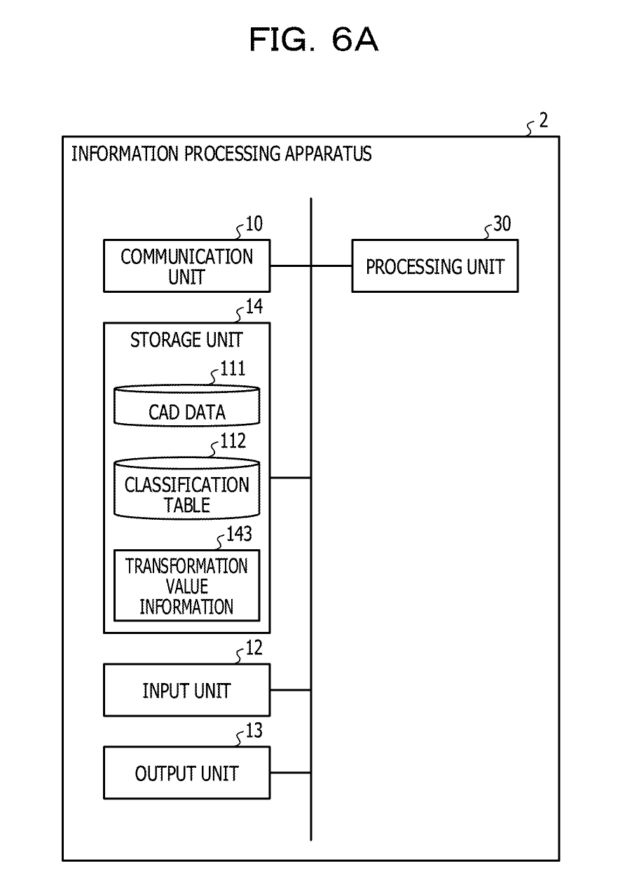

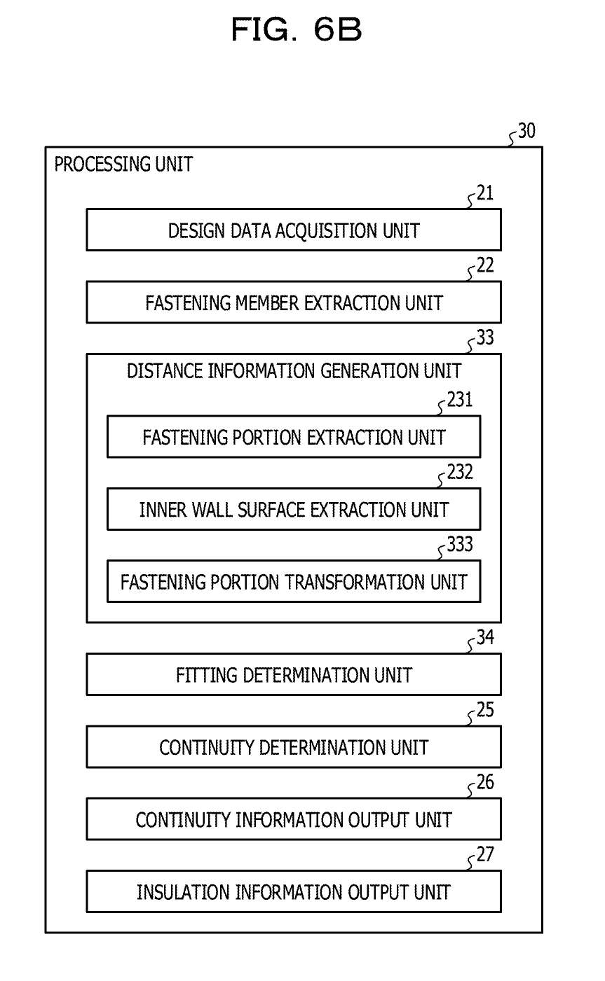

FIG. 6A is a circuit block diagram of an information processing apparatus that executes an installation position determination process, and FIG. 6B is a functional block diagram of a processing unit illustrated in FIG. 6A.

An information processing apparatus 2 is different from the information processing apparatus 1 in that the information processing apparatus 2 includes a storage unit 14 and a processing unit 30 instead of the storage unit 11 and the processing unit 20. The processing unit 30 is different from the processing unit 20 in that the processing unit 30 includes a distance information generation unit 33 and a fitting determination unit 34 instead of the distance information generation unit 23 and the fitting determination unit 24. The distance information generation unit 33 is different from the processing unit 20 in that the distance information generation unit 33 includes a fastening portion transformation unit 333 instead of the distance calculation unit 233. Since the configuration and the function of the component of the information processing apparatus 2 other than the storage unit 14, the fastening portion transformation unit 333, and the fitting determination unit 34 are the same as the configuration and the function of the component of the information processing apparatus 1, which has the same reference numeral, a detailed description thereof will be omitted herein.

The storage unit 14 is different from the storage unit 11 in that the storage unit 14 has transformation value information 143 instead of the threshold value information 113. Since the configuration and the function of the component of the storage unit 14 other than the transformation value information 143 are the same as the configuration and the function of the component of the storage unit 11, which has the same reference numeral, a detailed description thereof will be omitted herein.

The transformation value information 143 may include a single transformation value or a plurality of transformation values. The transformation value is, for example, the difference between the diameter of the valley of the thread of the fastening member and the desired diameter of the hole formed in the fastened member. The transformation value information 143 may include a plurality of transformation values corresponding to types of fastening members such as the screw defined by the predetermined standard such as, for example, the JIS standard.

(Fastening Member Continuity Determination Process by Information Processing Apparatus According to Second Embodiment)

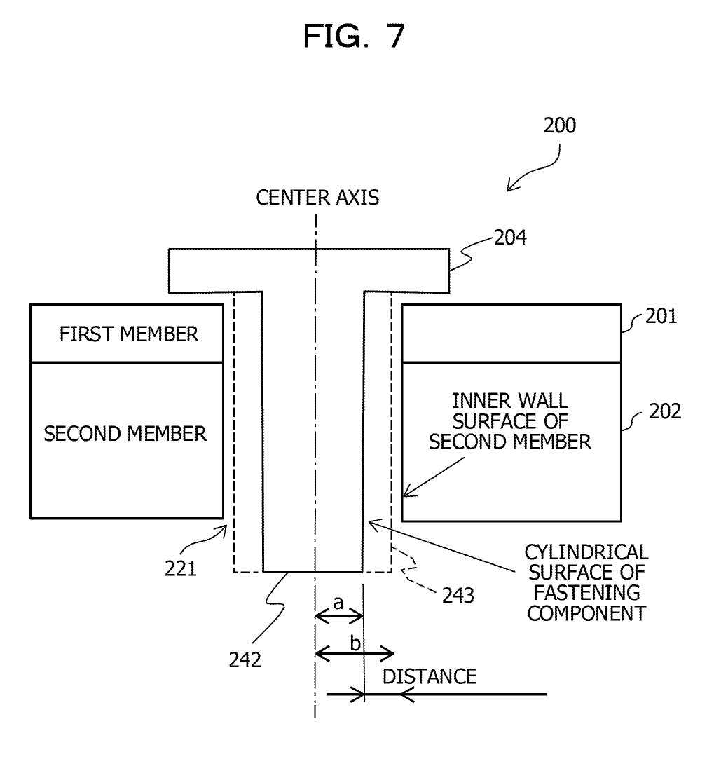

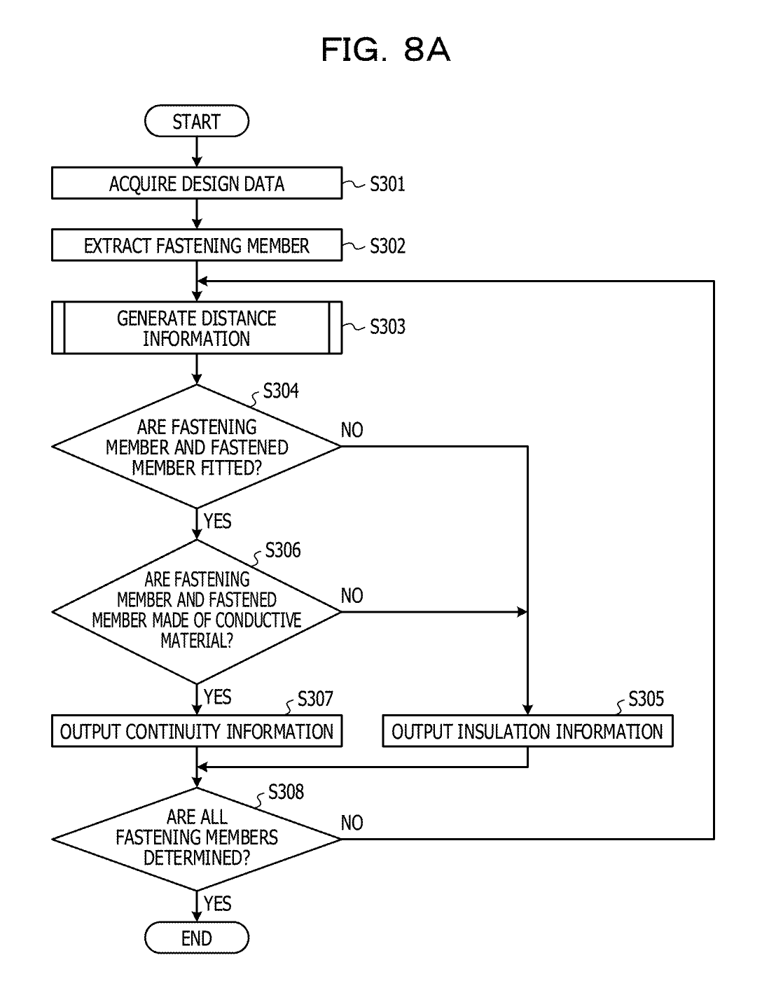

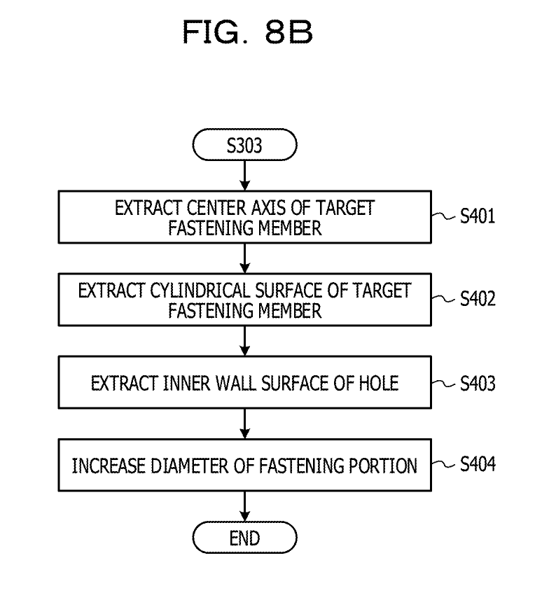

FIG. 7 is a diagram illustrating an outline of a fastening member continuity determination process, FIG. 8A is a flowchart of the fastening member continuity determination process by the information processing apparatus 2, and FIG. 8B is a flowchart illustrating a more detailed process of process S303 illustrated in FIG. 8A. The fastening member continuity determination process illustrated in FIG. 8A is executed mainly by the processing unit 30 in cooperation with each element of the information processing apparatus 2 based on the program stored in advance in the storage unit 14.

The fastening member continuity determination process by the information processing apparatus 2 will be described by taking the electronic device 200 having a first member 201, a second member 202, and a fastening member 204 illustrated in FIG. 7 as an example. The information processing apparatus 2 increases the diameter of a fastening portion 242 of the fastening member 204 according to the transformation value included in the transformation value information 143 to generate a fastening portion 243. When the fastening portion 243, the first member 201, and the second member 202 overlap with each other, the information processing apparatus 2 determines that the second member 202 and the fastening member 204 are fitted to each other. Moreover, when determining that the materials of both the second member 202 and the fastening member 204 are conductive materials, the information processing apparatus 2 outputs continuity information indicating that the second member 202 and the fastening member 204 are in a continuity state.

Since processes S301 and S302 are the same as processes S101 and S102, detailed descriptions thereof will be omitted herein. The distance information generation unit 33 generates the distance information related to the distance between the outer periphery of the fastening portion of the target fastening member which is any one of the fastening member extracted by process S302 and the inner wall of the hole of a target fastened member surrounding the periphery of the fastening portion of the target fastening member (S303).

Since processes S401 to S403 are the same as processes S201 to S203, detailed descriptions thereof will be omitted herein. Next, the fastening portion transformation unit 333 transforms the fastening portion formed by the cylindrical surface extracted in process of S402 so that the diameter increases according to the transformation value included in the transformation value information 143 (S404).

Next, the fitting determination unit 34 determines whether the fastening member and the fastened member are fitted to each other (S304). Specifically, when the fastening portion of the target fastening member of which the diameter increases by process S303 and the target fastened member in which the inner wall surface of the hole is extracted by process S303 overlap with each other, the fitting determination unit 34 determines whether the target fastening member and the target fastened member are fitted to each other (“YES” in S304). Meanwhile, when the fastening portion of the target fastening member of which the diameter increases by process S303 and the target fastened member in which the inner wall surface of the hole is extracted by process S303 do not overlap with each other, the fitting determination unit 34 determines that the target fastening member and the target fastened member are not fitted to each other (“NO” in S304).

(Operation and Effect of Information Processing Apparatus According to Second Embodiment)

The information processing apparatus according to the second embodiment determines that the fastening member and the fastened member are fitted to each other when the fastening portion of the fastening member of which the diameter increases and the fastened member overlap with each other. When determining that the fastening member and the fastened member are fitted to each other, the information processing apparatus determines whether materials of both the fastening member and the fastened member are conductive. In addition, when determining that the materials of both the fastening member and the fastened member are conductive, the information processing apparatus outputs continuity information indicating that the fastening member and the fastened member are in the continuity state. By executing such a process, the information processing apparatus may determine whether the fastening member and the fastened member are in the continuity state even when the fastening member and the fastened member are disposed to be isolated from each other in the CAD data.

(Configuration and Function of Information Processing Apparatus Executing Installation Position Determination Process According to Third Embodiment)

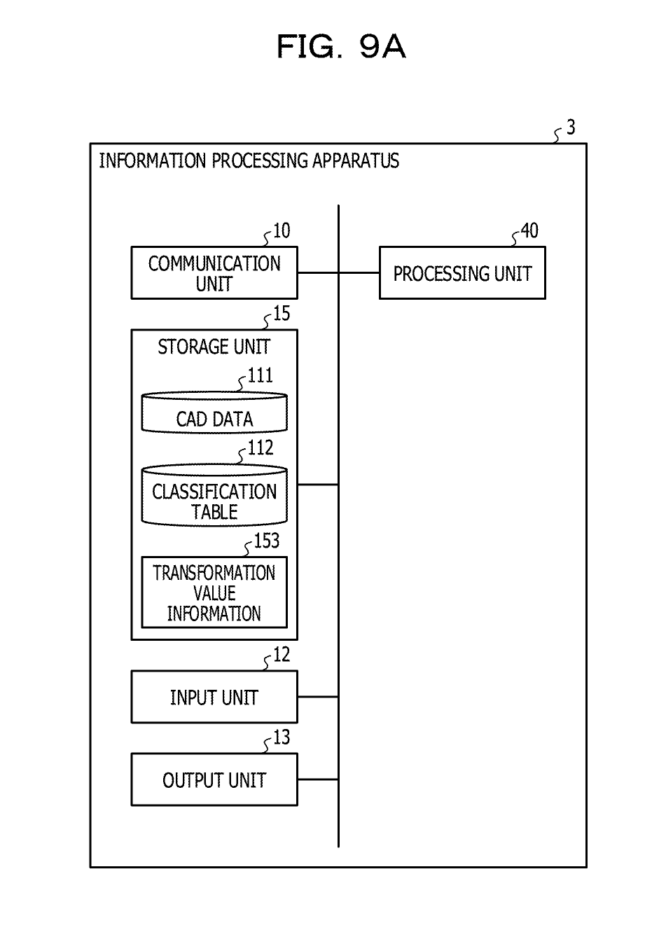

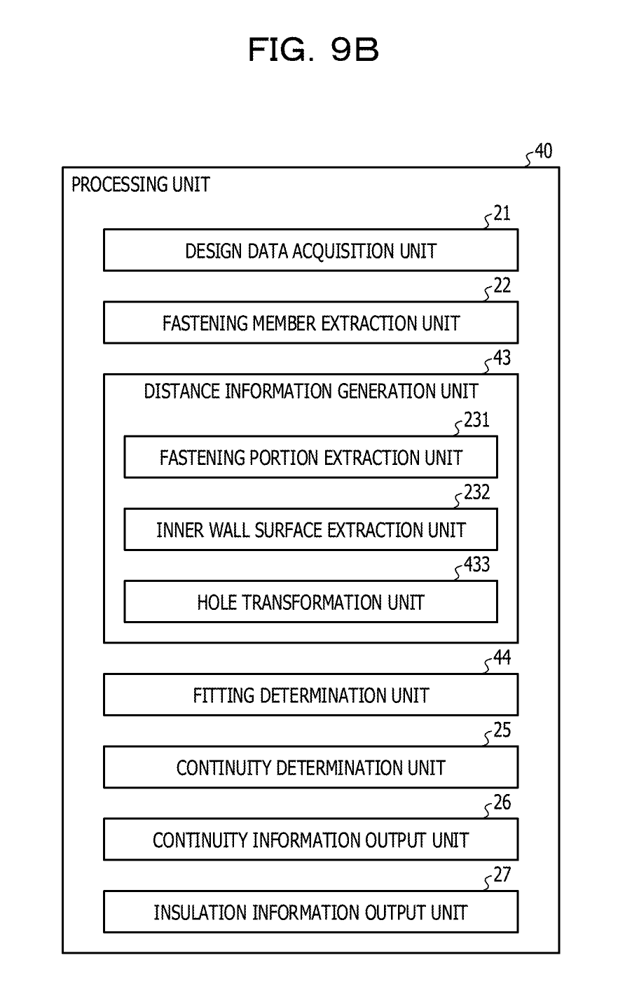

FIG. 9A is a circuit block diagram of an information processing apparatus that executes an installation position determination process according to a third embodiment, and FIG. 9B is a functional block diagram of a processing unit illustrated in FIG. 9A.

An information processing apparatus 3 is different from the information processing apparatus 1 in that the information processing apparatus 3 includes a storage unit 15 and a processing unit 40 instead of the storage unit 11 and the processing unit 20. The processing unit 40 is different from the processing unit 20 in that the processing unit 40 includes a distance information generation unit 43 and a fitting determination unit 44 instead of the distance information generation unit 23 and the fitting determination unit 24, respectively. The distance information generation unit 43 is different from the processing unit 20 in that the distance information generation unit 43 includes a hole transformation unit 433 instead of the distance calculation unit 233. Since the configuration and the function of the component of the information processing apparatus 3 other than the storage unit 14, the hole transformation unit 433, and the fitting determination unit 44 are the same as the configuration and the function of the component of the information processing apparatus 1, which has the same reference numeral, detailed descriptions thereof will be omitted herein.

The storage unit 15 is different from the storage unit 11 in that the storage unit 15 has transformation value information 153 instead of the threshold value information 113. Since the configuration and the function of the component of the storage unit 15 other than the transformation value information 153 are the same as the configuration and the function of the component of the storage unit 11, which has the same reference numeral, detailed descriptions thereof will be omitted herein.

The transformation value information 153 may include a single transformation value or a plurality of transformation values. The transformation value is, for example, the difference between the diameter of the valley of the thread of the fastening member and the desired diameter of the hole formed in the fastened member. The transformation value information 153 may include a plurality of transformation values corresponding to the types of fastening members such as the screw defined by the predetermined standard such as, for example, the JIS standard.

(Fastening Member Continuity Determination Process by Information Processing Apparatus According to Third Embodiment)

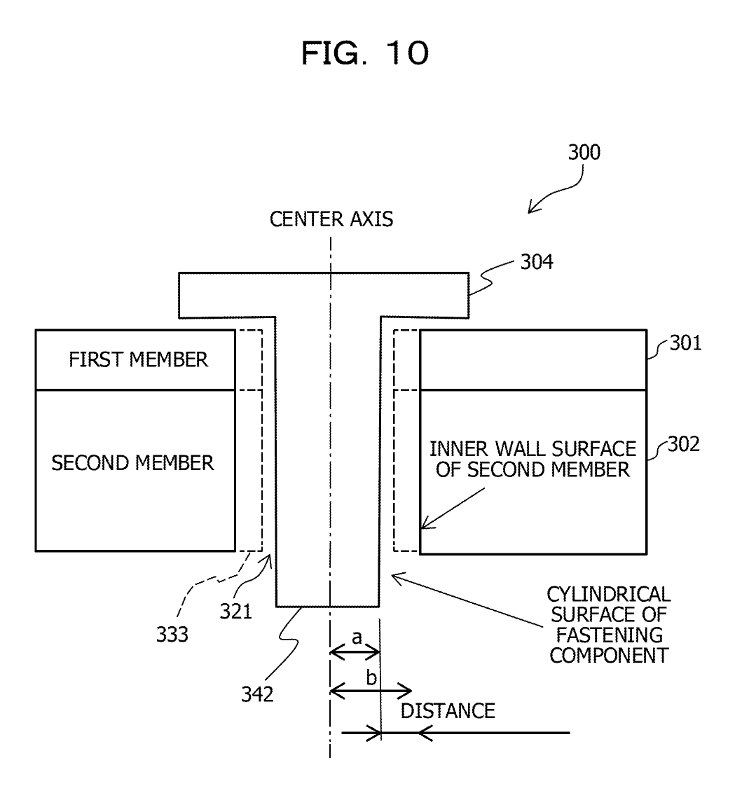

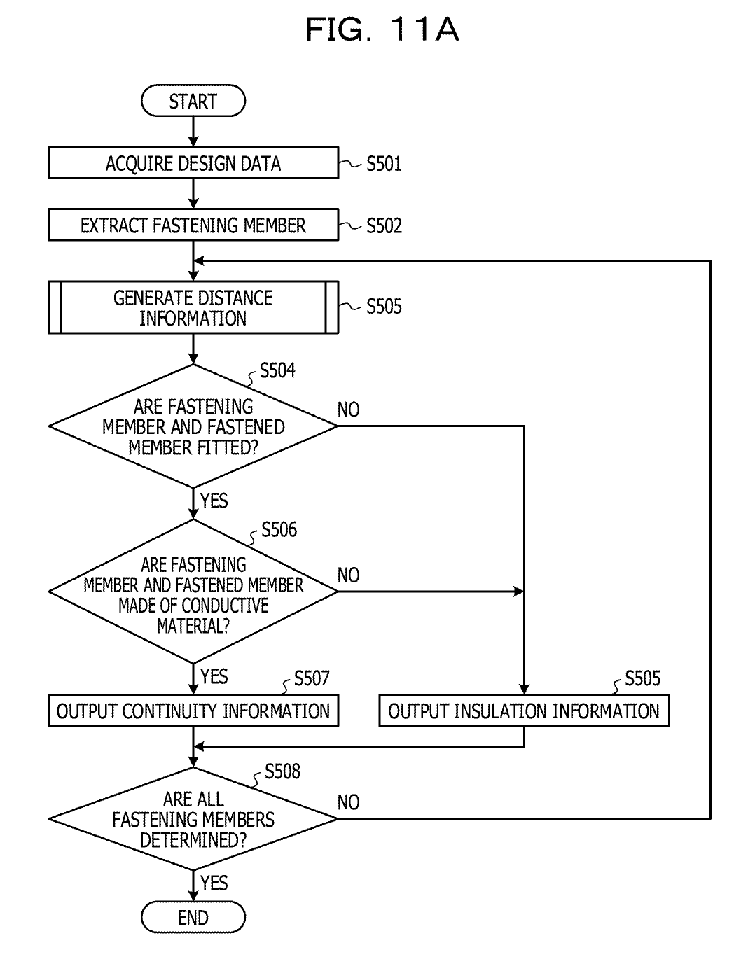

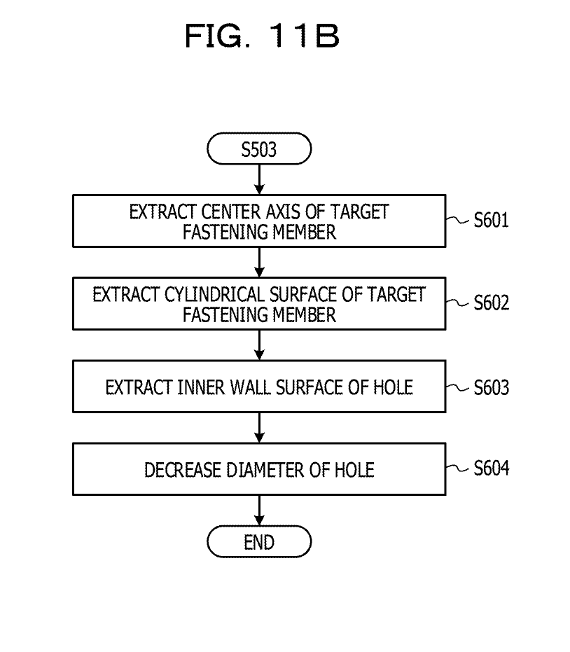

FIG. 10 is a diagram illustrating an outline of a fastening member continuity determination process by the information processing apparatus 2, FIG. 11A is a flowchart of the fastening member continuity determination process by the information processing apparatus 2, and FIG. 11B is a flowchart illustrating a more detailed process of process S603 illustrated in FIG. 11A. The fastening member continuity determination process illustrated in FIG. 11A is executed mainly by the processing unit 40 in cooperation with each element of the information processing apparatus 3 based on the program stored in advance in the storage unit 15.

The fastening member continuity determination process by the information processing apparatus 3 will be described by taking the electronic device 300 having a first member 302, a second member 304, and a fastening member 304 illustrated in FIG. 10, as an example. The information processing apparatus 3 decreases the diameters of a hole 311 of the first member 301 and a hole 321 of the second member 302 according to the transformation value included in the transformation value information 153 to generate holes 312 and 322. When the first member 301 and the second member 302 in which the diameters of the holes decrease, and a fastening portion 342 overlap with each other, the information processing apparatus 3 determines that the first member 301, the second member 302, and the fastening member 304 are fitted to each other. Moreover, when determining that the materials of both the second member 302 and the fastening member 304 are conductive materials, the information processing apparatus 3 outputs continuity information indicating that the second member 302 and the fastening member 304 are in a continuity state.

Since processes S501 and S502 are the same as processes S101 and S102, a detailed description will be omitted herein. The distance information generation unit 43 generates the distance information related to the distance between the outer periphery of the fastening portion of the a target fastening member which is any one of the fastening member extracted by process S502 and the inner wall of the hole of a target fastened member surrounding the periphery of the fastening portion of the target fastening member (S503).

Since processes S601 to S603 are the same as processes S201 to S203, a detailed description will be omitted herein. Next, a hole transformation unit 433 transforms the hole of which inner wall surface is extracted by process of S603 so that the diameter decreases according to the transformation value included in the transformation value information 153 (S604).

Next, the fitting determination unit 44 determines whether the fastening member and the fastened member are fitted to each other (S504). Specifically, when the fastening portion of the target fastening member of which the outer periphery is extracted by process S503 and the target fastened member in which the diameter of the hole decreases by process S503 overlap with each other, the fitting determination unit 44 determines that the target fastening member and the target fastened member are fitted to each other (“YES” in S504). Meanwhile, when the fastening portion of the target fastening member of which the outer periphery is extracted by process S503 and the target fastened member in which the diameter of the hole decreases by process S503 do not overlap with each other, the fitting determination unit 44 determines that the target fastening member and the target fastened member are not fitted to each other (“NO” in S504).

(Operation and Effect of Information Processing Apparatus According to Third Embodiment)

The information processing apparatus according to the third embodiment determines that the fastening member and the fastened member are fitted to each other when the fastening portion of the fastening member and the fastened member in which the diameter of the hole decreases overlap with each other. When determining that the fastening member and the fastened member are fitted to each other, the information processing apparatus determines whether materials of both the fastening member and the fastened member are conductive. In addition, when determining that the materials of both the fastening member and the fastened member are conductive, the information processing apparatus outputs continuity information indicating that the fastening member and the fastened member are in the continuity state. By executing such a process, the information processing apparatus may determine whether the fastening member and the fastened member are in the continuity state even when the fastening member and the fastened member are disposed to be isolated from each other in the CAD data.

(Configuration and Function of Information Processing Apparatus Executing Installation Position Determination Process According to Fourth Embodiment)

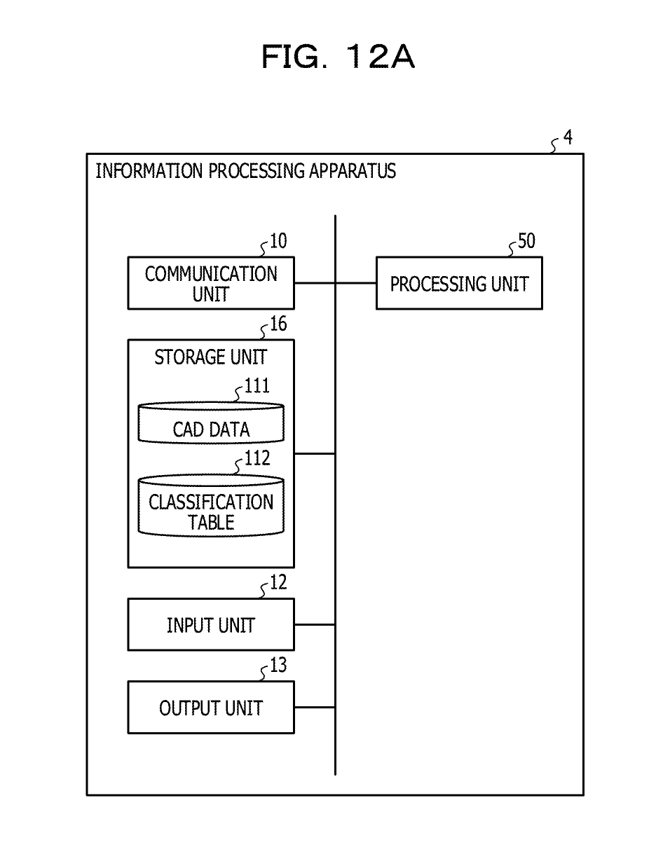

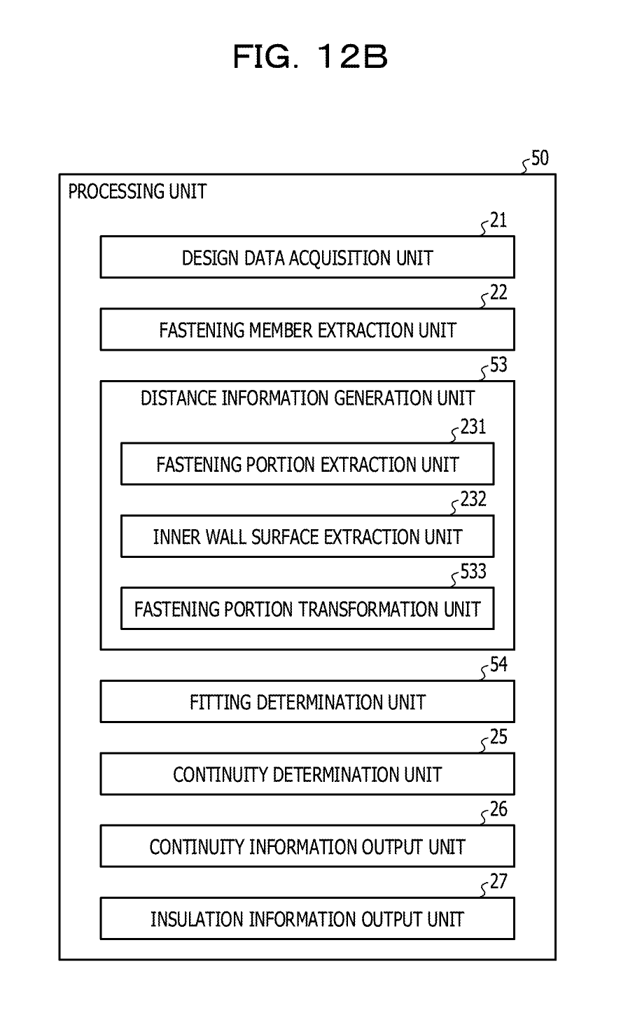

FIG. 12A is a circuit block diagram of an information processing apparatus that executes an installation position determination process, and FIG. 12B is a functional block diagram of a processing unit illustrated in FIG. 12A.

An information processing apparatus 4 is different from the information processing apparatus 1 in that the information processing apparatus 4 includes a storage unit 16 and a processing unit 50 instead of the storage unit 11 and the processing unit 20. The processing unit 50 is different from the processing unit 20 in that the processing unit 50 includes a distance information generation unit 53 and a fitting determination unit 54 instead of the distance information generation unit 23 and the fitting determination unit 24. The distance information generation unit 53 is different from the processing unit 20 in that the distance information generation unit 53 includes a fastening portion transformation unit 533 instead of the distance calculation unit 233. Since the configuration and the function of the component of the information processing apparatus 4 other than the storage unit 16, the fastening portion transformation unit 533, and the fitting determination unit 54 are the same as the configuration and the function of the component of the information processing apparatus 1, which has the same reference numeral, detailed descriptions thereof will be omitted herein.

The storage unit 16 is different from the storage unit 11 in that the storage unit 16 does not have the threshold value information 113. Since the configuration and the function of another component of the storage unit 16 is the same as the configuration and the function of the component of the storage unit 11, which has the same reference numeral, a detailed description thereof will be omitted herein.

(Fastening Member Continuity Determination Process by Information Processing Apparatus According to Fourth Embodiment)

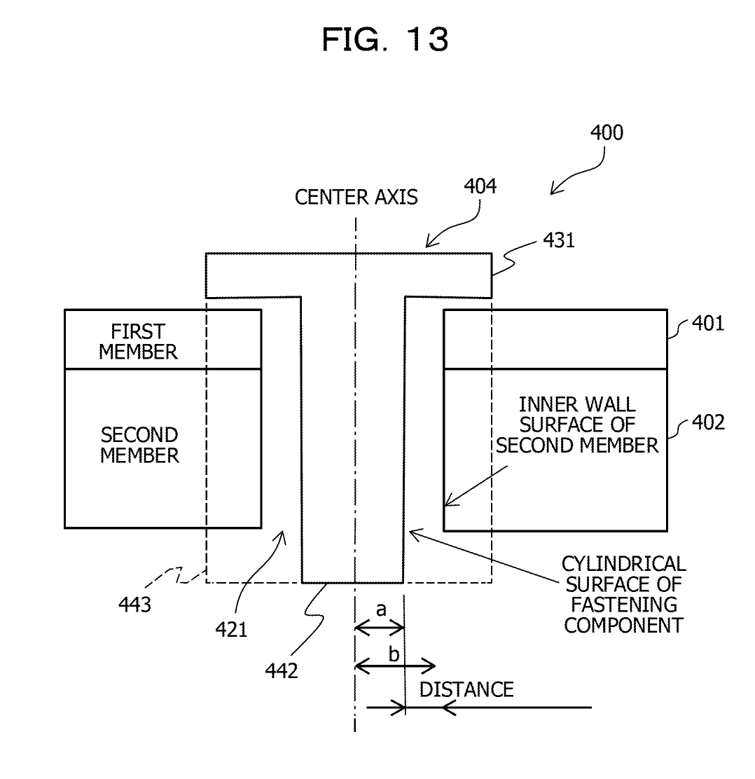

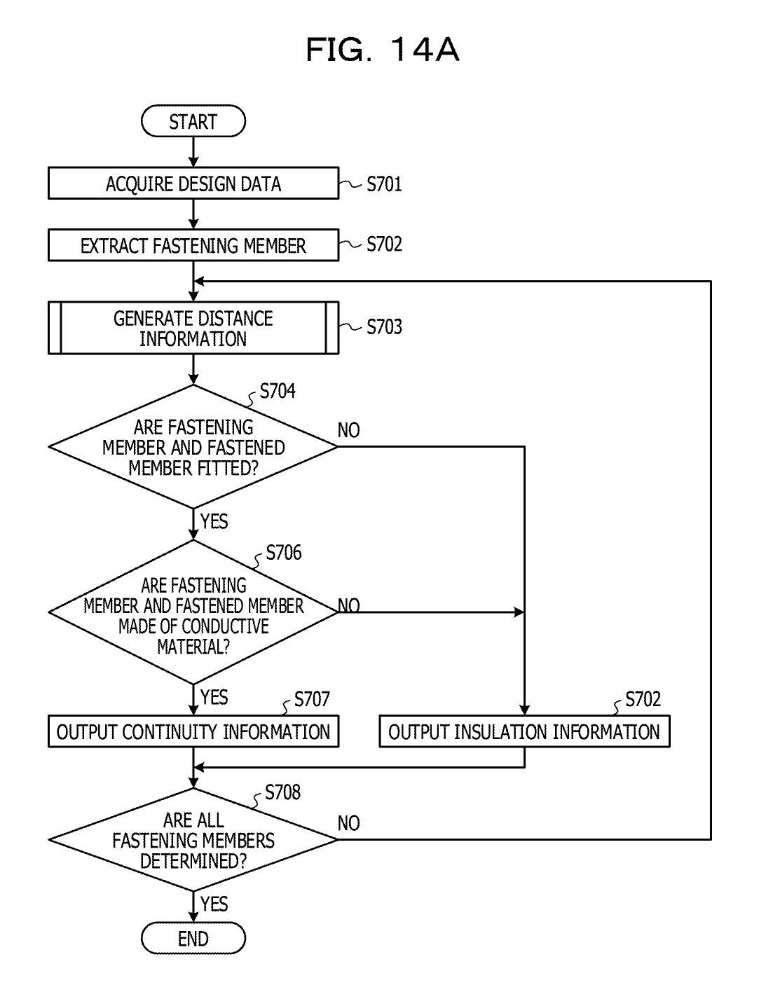

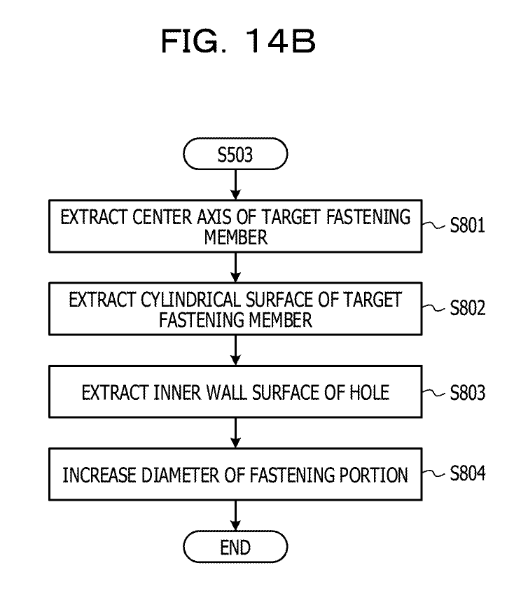

FIG. 13 is a diagram illustrating an outline of a fastening member continuity determination process by the information processing apparatus 4, FIG. 14A is a flowchart of the fastening member continuity determination process by the information processing apparatus 4, and FIG. 14B is a flowchart illustrating a more detailed process of process S703 illustrated in FIG. 14A. The fastening member continuity determination process illustrated in FIG. 14A is executed mainly by the processing unit 50 in cooperation with each element of the information processing apparatus 4 based on the program stored in advance in the storage unit 16.

The fastening member continuity determination process by the information processing apparatus 4 will be described by taking the electronic device 400 having a first member 401, a second member 402, and a fastening member 404 illustrated in FIG. 13, as an example. The information processing apparatus 4 increases the diameter of a fastening portion 442 of the fastening member 404 to be equal to the diameter of a screw head 431 to generate a fastening portion 443. When the fastening portion 443, the first member 401, and the second member 402 overlap with each other, the information processing apparatus 4 determines that the first member 401, the second member 402, and the fastening member 404 are fitted to each other. Moreover, when determining that the materials of both the second member 402 and the fastening member 404 are conductive materials, the information processing apparatus 4 outputs continuity information indicating that the second member 402 and the fastening member 404 are in a continuity state.

Since processes S701 and S702 are the same as processes S101 and S102, a detailed description will be omitted herein. The distance information generation unit 53 generates the distance information related to the distance between the outer periphery of the fastening portion of the a target fastening member which is any one of the fastening member extracted by process S702 and the inner wall of the hole of a target fastened member surrounding the periphery of the fastening portion of the target fastening member (S703).

Since processes S801 to S803 are the same as processes S201 to S203, detailed descriptions thereof will be omitted herein. Next, the fastening portion transformation unit 533 transforms the fastening portion formed by the cylindrical surface extracted in process of S802 so that the diameter matches the diameter of the screw head of the target fastening member (S804).

Next, the fitting determination unit 54 determines whether the fastening member and the fastened member are fitted to each other (S504). Specifically, when the fastening portion of the target fastening member of which the diameter increases by process S703 and the target fastened member in which the inner wall surface of the hole is extracted by process S703 overlap with each other, the fitting determination unit 54 determines whether the target fastening member and the target fastened member are fitted to each other (“YES” in S704). Meanwhile, when the fastening portion of the target fastening member of which the diameter increases by process S703 and the target fastened member in which the inner wall surface of the hole is extracted by process S703 do not overlap with each other, the fitting determination unit 54 determines that the target fastening member and the target fastened member are not fitted to each other (“NO” in S704).

(Operation and Effect of Information Processing Apparatus According to Fourth Embodiment)

The information processing apparatus according to the fourth embodiment determines that the fastening member and the fastened member are fitted to each other when the fastening portion of the fastening member transformed so that the diameter matches the diameter of the screw head, and the fastened member overlap with each other. When determining that the fastening member and the fastened member are fitted to each other, the information processing apparatus according to the fourth embodiment determines whether the materials of both the fastening member and the fastened member are conductive. In addition, when determining that the materials of both the fastening member and the fastened member are conductive, the information processing apparatus according to the fourth embodiment outputs continuity information indicating that the fastening member and the fastened member are in the continuity state. By executing such a process, the information processing apparatus according to the fourth embodiment may determine whether the fastening member and the fastened member are in the continuity state even when the fastening member and the fastened member are disposed to be isolated from each other in the CAD data.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium recording a fastening member continuity determination program that causes a computer to execute a process, the process comprising:
acquiring design data including information indicating a shape and a position of a fastening member having a cylindrical fastening portion and information indicating a shape and a position of a fastened member having a hole in which an inner wall is disposed to be isolated from an outer periphery of the fastening portion;
generating distance information related to a distance between the outer periphery of the fastening portion and the inner wall of the hole;
determining whether the fastening member and the fastened member are fitted to each other based on the distance information;
determining, when determining that the fastening member and the fastened member are fitted to each other, whether materials of both the fastening member and the fastened member are conductive; and
outputting, when determining that the materials of both the fastening member and the fastened member are conductive, continuity information indicating that the fastening member and the fastened member are in a continuity state.

2. The non-transitory computer-readable recording medium according to claim 1, the process further comprising:
outputting, when determining that the fastening member and the fastened member are not fitted to each other, insulation information indicating that the fastening member and the fastened member are in an insulation state.

3. The non-transitory computer-readable recording medium according to claim 2, the process further comprising:
outputting the insulation information when determining that the material of at least one of the fastening member and the fastened member is an insulative material.

4. The non-transitory computer-readable recording medium according to claim 1, wherein information indicating whether the fastening member and the fastened member are conductive or insulative is acquired.

5. The non-transitory computer-readable recording medium according to claim 1, wherein in the process of the generating the distance information, a distance between the outer periphery of the fastening member and the inner wall of the hole is calculated, and in the process of the determining whether the fastening member and the fastened member are fitted to each other, it is determined whether the distance between the outer periphery of the fastening member and the inner wall of the hole is equal to or less than a threshold value.

6. The non-transitory computer-readable recording medium according to claim 1, wherein in the process of the generating the distance information, a diameter of the fastening portion increases, and in the process of the determining whether the fastening member and the fastened member are fitted to each other, it is determined whether the fastening member of which the diameters increase and the fastened member overlap with each other.

7. The non-transitory computer-readable recording medium according to claim 1, wherein in the process of the generating the distance information, the diameter of the hole decreases, and in the process of the determining whether the fastening member and the fastened member are fitted to each other, it is determined whether the fastening portion and the fastened member in which the diameter of the hole decreases overlap with each other.

8. A fastening member continuity determination method comprising:
acquiring, by a computer, design data including information indicating a shape and a position of a fastening member having a cylindrical fastening portion and information indicating a shape and a position of a fastened member having a hole in which an inner wall is disposed to be isolated from an outer periphery of the fastening portion;
generating distance information related to a distance between the outer periphery of the fastening portion and the inner wall of the hole;
determining whether the fastening member and the fastened member are fitted to each other based on the distance information;
determining, when determining that the fastening member and the fastened member are fitted to each other, whether materials of both the fastening member and the fastened member are conductive; and
outputting, when determining that the materials of both the fastening member and the fastened member are conductive, continuity information indicating that the fastening member and the fastened member are in a continuity state.

9. The fastening member continuity determination method according to claim 8, further comprising:
outputting, when determining that the fastening member and the fastened member are not fitted to each other, insulation information indicating that the fastening member and the fastened member are in an insulation state.

10. The fastening member continuity determination method according to claim 9, further comprising:
outputting the insulation information when determining that the material of at least one of the fastening member and the fastened member is an insulative material.

11. The fastening member continuity determination method according to claim 8, wherein information indicating whether the fastening member and the fastened member are conductive or insulative is acquired.

12. The fastening member continuity determination method according to claim 8, wherein in a process of the generating the distance information, a distance between the outer periphery of the fastening member and the inner wall of the hole is calculated, and in a process of the determining whether the fastening member and the fastened member are fitted to each other, it is determined whether the distance between the outer periphery of the fastening member and the inner wall of the hole is equal to or less than a threshold value.

13. The fastening member continuity determination method according to claim 8, wherein in a process of the generating the distance information, a diameter of the fastening portion increases, and in a process of the determining whether the fastening member and the fastened member are fitted to each other, it is determined whether the fastening member of which the diameters increase and the fastened member overlap with each other.

14. The fastening member continuity determination method according to claim 8, wherein in a process of the generating the distance information, the diameter of the hole decreases, and in a process of the determining whether the fastening member and the fastened member are fitted to each other, it is determined whether the fastening portion and the fastened member in which the diameter of the hole decreases overlap with each other.

15. An information processing apparatus comprising:
a memory; and
a processor coupled to the memory and configured to perform a process of:
acquiring design data including information indicating a shape and a position of a fastening member having a cylindrical fastening portion and information indicating a shape and a position of a fastened member having a hole in which an inner wall is disposed to be isolated from an outer periphery of the fastening portion;
generating distance information related to a distance between the outer periphery of the fastening portion and the inner wall of the hole;
determining whether the fastening member and the fastened member are fitted to each other based on the distance information;
determining, when determining that the fastening member and the fastened member are fitted to each other, whether materials of both the fastening member and the fastened member are conductive; and
outputting, when determining that the materials of both the fastening member and the fastened member are conductive, continuity information indicating that the fastening member and the fastened member are in a continuity state.

16. The information processing apparatus according to claim 15, wherein the processor is configured to:
output, when determining that the fastening member and the fastened member are not fitted to each other, insulation information indicating that the fastening member and the fastened member are in an insulation state.

17. The information processing apparatus according to claim 15, wherein the processor acquires information indicating whether the fastening member and the fastened member are conductive or insulative.

18. The information processing apparatus according to claim 16, wherein in the process of the generating the distance information, the processor calculates a distance between the outer periphery of the fastening member and the inner wall of the hole, and in the process of the determining whether the fastening member and the fastened member are fitted to each other, the processor determines whether the distance between the outer periphery of the fastening member and the inner wall of the hole is equal to or less than a threshold value.

19. The information processing apparatus according to claim 15, wherein in the process of the generating the distance information, the processor increases a diameter of the fastening portion, and in the process of the determining whether the fastening member and the fastened member are fitted to each other, the processor determines whether the fastening member of which the diameters increase and the fastened member overlap with each other.

20. The information processing apparatus according to claim 15, wherein in the process of the generating the distance information, the processor decrease the diameter of the hole, and in the process of the determining whether the fastening member and the fastened member are fitted to each other, the processor determines whether the fastening portion and the fastened member in which the diameter of the hole decreases overlap with each other.
